(19) United States
(12) Patent Application Publication
(10) Pub. No.: US 2010/0282172 A1
(43) Pub. Date: Nov. 11, 2010

(54) TEAT PREPARATION STATION AND METHOD FOR TEAT PREPARATION

(75) Inventors: Jan Eriksson, Uttran (SE); Thomas Axelsson, Farsta (SE); Gert Danneker, Grodinge (SE)

Correspondence Address: YOUNG & THOMPSON, 209 Madison Street, Suite 500, Alexandria, VA, 22314, US

(73) Assignee: DELAVAL HOLDING AB, Tumba (SE)

(21) Appl. No.: 12/599,304

(22) PCT Filed: May 7, 2008
(86) PCT No.: PCT/SE2008/050528

§ 371 Date: Jul. 30, 2010

(30) Foreign Application Priority Data
May 9, 2007 (SE) 0701116-6

(51) Int. Cl. A01J 5/013; A01J 5/00; A01J 5/003; A01J 5/007

(52) U.S. Cl. 119/14.02; 119/14.03; 119/14.18; 119/14.04; 119/14.01; 119/14.08

(57) ABSTRACT

A teat preparation station(1) for preparation of teats of milking animals prior to being milked in a milking system (11) equipped with at least one milking stall(13) is provided. The teat preparation station (1) includes a teat preparation area (2) housing at least one milking animal at a time; an exit (4) leading to the milking system; pre-milking equipment (5) provided for automatically pre-milking milking animals in the teat preparation area; and milk quality analyzing equipment (6) provided for automatically analyzing pre-milk from the milking animals.

### TECHNICAL FIELD OF THE INVENTION

The present invention relates generally to dairy farming, and more specifically to stations and methods as defined in the preambles of the appended independent patent claims.

### DESCRIPTION OF RELATED ART

Such a teat preparation station is known from EP 0 830 055 B1 (MAASLAND). The teat preparation station as being illustrated in FIG. 2 of the patent comprises, near the entrance gate 9 of the carrousel 1, a teat preparation station comprising an entrance door 12, fencing 5, and a computer-controlled entrance door 30 giving access to the platform 2 of the carrousel 1. A cleaning/foremilking device 16, which is disposed so as to be movable via the rail 15A, is provided. By means of the cleaning/foremilking device 16, the teats and/or the udder can be washed and be foremilked.

The cleaning/foremilking device 16 comprises a robot arm 17, which is provided at one end with a cleaning/foremilking element 18, capable of being connected to the udder and/or the teats, and at its other end with a guiding sleeve 19 which is movable via the rail 15. The robot arm 17 is further capable of pivoting on two substantially vertical hinge pins 20.

In FIG. 1 of EP 0 830 055 B1 is disclosed an embodiment wherein the cleaning/foremilking is performed after the milking animal has accessed the platform 2 of the carrousel 1.

### SUMMARY OF THE INVENTION

The arrangements of EP 0 830 055 B1 lack capabilities of establishing milk quality and health of the milking animals before entering the platform of the rotary kind of milking system. If such analysis should be performed once the milking animals have entered the platform, the capacity of the milking system may be reduced.

Further, such analysis would have to compete with milking equipment, hoses, valves, etc. about the limited space around the milking animal in the milking stall.

Yet further, the arrangements of EP 0 830 055 B1 lack capabilities of guiding an animal to other place than to the platform of the rotary kind of milking system once the cleaning/foremilking has been performed. This means inevitably that all milking animals have to enter the milking system and be milked, or at least to occupy a milking position, in the milking system. This is a drawback if a milking animal is ill since it may contaminate other milking animals in the milking system. In the latter scenario, the capacity of the milking system is reduced further.

Still further, milking animals that have injured udders, cuts or wounds are entering the platform of the milking system for milking instead of being treated for their injuries.

Yet further, milking animals producing milk of different qualities enter the milking system without that the milking system has information about this. Thus, milk of different qualities cannot be collected in different containers, or if the qualities are analyzed in the milking system, a further delay therein is obtained.

An object of the present invention is thus to provide a station and a method, respectively, for teat preparation that alleviate or reduce at least some of the problems and shortcomings of the arrangements of EP 0 830 055 B1.

This object, among others, is according to the present invention attained by stations and methods as specified in the appended patent claims.

According to a first aspect of the invention there is provided a teat preparation station for preparation of teats of milking animals prior to intentionally being milked in a milking system or arrangement comprising at least one milking stall. The teat preparation station comprises a teat preparation area housing at least one milking animal at a time; a first exit leading to the milking arrangement; pre-milking equipment provided for automatically pre-milking milking animals in the teat preparation area; and milk quality analyzing equipment provided for automatically analyzing pre-milk from the milking animals; and/or teat and/or udder inspection equipment provided for automatically inspecting the teats and/or udders of the milking animals.

That is, the teat preparation station is located physically separated from the milking system. By such provision information regarding the quality of the milk produced by each of the milking animals and/or the condition of the teats and/or udders of the milking animals can be determined before the milking animal enters the milking arrangement. The determination may be used to decide upon whether the respective milking animal is healthy or ill. Such information may be used as basis for the decision if the milking animal should be milked, how the milking animal should be milked or otherwise treated, and/or how the milk from the respective should be collected or treated. Therefore, the information is advantageously passed on to the milking system.

Milking animals having injured udders, cuts or wounds can be prevented from entering the milking system and instead being treated for their injuries.

In one embodiment of the invention, the teat preparation station comprises a second exit leading to any of a waiting, treating, resting, and/or feeding area or to a milking area separate from the milking system; and a door or gate device for automatically letting each of the milking animals to leave the teat preparation station through a selected one of the first and second exits.

Advantageously, a processing device or similar is provided for automatically determining, for each of the milking animals, whether the milking animal is healthy or ill, wherein the gate device is controlled to automatically let healthy milking animals to leave the teat preparation station through the first exit and ill animals to leave the teat preparation station through the second exit.

Hereby, healthy animals can be directed to the milking system in order to be milked therein, whereas ill animals are directed elsewhere.

If the second exit leads to a waiting area, the ill milking animals can be kept therein while the healthy milking animals are milked in the milking system. When all healthy milking animals have been milked, the ill milking animals can be milked in the milking system. After the ill milking animals have been milked in the milking system, the milking system can be cleaned in order not to pass on bacteria or other contaminants to yet other animals.

If the second exit leads to a milking area separate from the milking system, the ill milking animals can be milked, and optionally treated, in such separate milking area.

If the second exit leads to any of a treating, resting, or feeding area, the ill milking animals may not be milked at all, but can be treated, allowed to rest, or fed.

It shall be appreciated that the first and second exits may be exchanged for a single exit of the teat preparation station and a selection box or similar that would be capable of directing the milking animals to either the milking system or to the waiting, treating, resting, and/or feeding area or to the milking area separate from the milking system. Hereby, a similar functionality is achieved.

In yet another embodiment of the invention, the teat preparation station comprises teat preparation equipment configured to automatically prepare teats of milking animals in the teat preparation area by means of applying at least one substance to the teats of the milking animals. Subsequently, the teats are cleaned and/or flushed with e.g. water to remove the substance. After such cleaning and/or flushing, teat analyzing equipment is provided to automatically measure the presence of the substance applied to the teats of the milking animals either directly at teats of the milking animals or by analyzing a fluid that is passed by the teats of the milking animals. Such measurement is made to assure that the substance is no longer present at the teat of the milking animals when they are allowed to leave the teat preparation station for e.g. milking. Hereby, it can be assured that the substance will not make its way to the milk tank together with the milk during milking.

The substance may be a cleaning substance such as a detergent, a cleaning additive, a disinfection substance such as iodine, a pre-milking dipping substance such as a halogen-containing hydrocarbon substance, or a trace substance mixed with any other active substance and used for the sole purpose as a tracer for the active substance with which it was mixed.

If the substance is still present, a further cleaning or flushing procedure of the teats may be performed, or a neutralizing agent or chemical reactant may be added, whichever will be the case, to remove residues of the substance that are still left at the teats.

According to a second aspect of the invention there is provided a method for preparing teats of milking animals in a teat preparation station prior to intentionally being milked in a milking system or arrangement. According to the method milking animals are received in a teat preparation area capable of housing at least one milking animal at a time and having an exit leading to the milking system. The milking animals are automatically pre-milked in the teat preparation area by pre-milking equipment, and the pre-milk from the milking animals is automatically analyzed by milk quality analyzing equipment teat and/or the teats and/or udders of the milking animals are automatically inspected by udder inspection equipment.

Hereby, depending on the analysis of the pre-milk and/or the inspection, each of the milking animals may for instance (i) be guided to the milking system and milked therein, (ii) be guided to the milking system but not milked therein, (iii) be guided to a waiting area and then, after other milking animals have been milked in the milking system, be guided to the milking system and milked therein, (iv) be guided to other milking area and milked therein, or (v) be guided to a treating area for treatment and not milked at all at this time.

A very flexible milking animal management arrangement is obtained, and by separating milking and teat preparation to different areas, the milking animals can be milked fastly and efficiently once they have entered the milking system. A higher throughput of milking animals is obtained and the milking capacity of the milking system is increased. Alternatively, for a given milking capacity the milking system may be designed with fewer milking stalls, which thus reduces investment.

Further characteristics of the invention and advantages thereof, will be evident from the following detailed description of preferred embodiments of the present invention given hereinafter and the accompanying FIGS. 1-3, which are given by way of illustration only, and thus are not limitative of the present invention.

In the following detailed description the milk producing animals are cows. However, the invention is not limited to cows, but is applicable to any animals having the capability to produce milk.

### BRIEF DESCRIPTION OF THE DRAWINGS

FIGS. 1-3 illustrate each, schematically, an arrangement for managing cows including a teat preparation station according to a respective embodiment of the present invention.

### DETAILED DESCRIPTION OF EMBODIMENTS

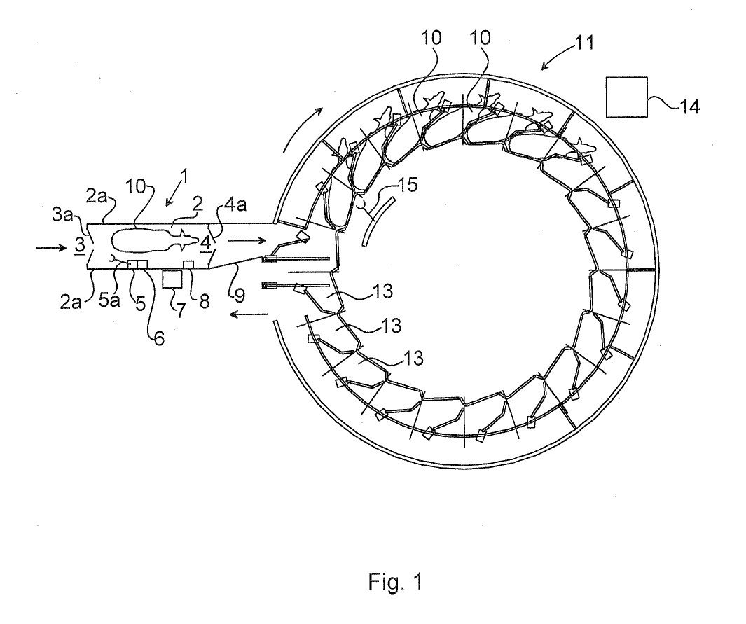

The arrangement for managing cows as illustrated in FIG. 1 comprises a milking system 11 and a teat preparation station 1 arranged in front of the milking system or arrangement 11. The teat preparation station 1 comprises a teat preparation area 2 having an entrance 3 and an exit 4 at two opposite ends of the teat preparation area 2. The teat preparation area 2 is enclosed by an entrance door or gate 3a at the entrance 3, an exit door or gate 4a at the exit 4 and fencing 2a at the sides, and is preferably designed to house one cow 10 at a time. The exit gate 4a leads preferably to the milking system 11, which is located next to the teat preparation station 1.

The exit 4 of the teat preparation station 1 can lead to the milking system 11 via a passage way 9, or the teat preparation station may be located up against the milking system.

The teat preparation station 1 comprises further teat preparation equipment 5, analyzing equipment 6, a processing and control device 7, and a cow identification device 8. Each of the entrance gate 3a, the exit gate 4a, the teat preparation equipment 5, the analyzing equipment 6, and the cow identification device 8 may be controlled by the processing and control device 7, and the analyzing equipment 6 and the cow identification device 8 may forward measurement values and cow identity information to the processing and control device 7.

The teat preparation equipment 5 may comprise both teat cleaning and pre-milking equipment. The teat cleaning equipment is provided for automatically cleaning teats of cows 10 in the teat preparation area 2 and the pre-milking equipment is provided for automatically pre-milking cows 10 in the teat preparation area 2.

Teat cleaning and pre-milking equipment that can be used in the present invention comprise those disclosed in U.S. Pat. No. 6,626,130; U.S. Pat. No. 6,591,784; U.S. Pat. No. 6,553,942; U.S. Pat. No. 5,211,132; U.S. Pat. No. 5,235,937; and U.S. Pat. No. 4,305,346; U.S. Pat. No. 6,321,682; B1 U.S. Pat. No. 6,155,204; EP 0 830 055 B1; and WO 2005/067702 A1, either directly or after modifications readily made by a person skilled in the art. The contents of the above documents are hereby enclosed by reference.

The teat cleaning and pre-milking equipment 5 may comprises a robot arm 5a provided for attaching at least one end of the teat cleaning and pre-milking equipment to the teats of the cows 10 such as the being disclosed in EP 0 830 055 B1.

The analyzing equipment 6 may comprise both milk quality analyzing equipment provided for automatically analyzing pre-milk from the cows 10 and teat and/or udder inspection equipment provided for automatically inspecting the teats and/or udders of the cows 10 in the teat preparation area 2.

The milk quality analyzing equipment may optionally be provided for detecting abnormal milk from each of the cows indicating that the cow is ill. It may include equipment for measuring conductivity, somatic cells, bacteria, or particles in milk from each of the cows.

Milk quality analyzing equipment that can be used in the present invention comprise conductivity meters as those disclosed in U.S. Pat. No. 3,762,371; U.S. Pat. No. 5,416,417; U.S. Pat. No. 5,302,903; U.S. Pat. No. 6,307,362 B1; and U.S. Pat. no. 6,378,455 B1, ion selective sensors as those disclosed in WO 2005/0068; U.S. Pat. No. 494,844,097; U.S. Pat. No. 6,290,838 B1; U.S. Pat. No. 6,297,871 B1; chemiluminescence activity measurement devices as that disclosed in U.S. Pat. No. 6,297,045, and optical detector devices as those disclosed in WO 00/27183, EP 1 180 675 A2; EP 1 000 535 A1; DD 293 429 A5; WO 2004/073391; and J. A. Baro, P. roldán, C. E. Carleos, G. J. Grillo, and M. A. Pérez, Video microscopy as an alternative method for somatic cell count in milk, journal of dairy research (2005) 72, 93-100, either directly or after modifications readily made by a person skilled in the art. The contents of the above documents are hereby incorporated by reference.

In one version the milk quality analyzing equipment is provided for measuring the occurrence of flocculation in milk from each of the cows. Conveniently, the milk quality analyzing equipment is in this embodiment provided for non-contacting measurements, particularly optical measurements. Pre-milk form a single teats or from several teats of a cow is led to a measurement cell, which may advantageously be arranged close to the teat(s) of the cow during pre-milking; and images are taken by a digital camera continuously or intermittently. Floccules are detected automatically in the images by suitable digital imaging processing software.

Teat and/or udder inspection equipment may be based on optical sensors as those referred to above, ultrasound sensors, thermo sensors, etc.

Additionally, or alternatively, the milk and/or teat and/or udder inspection equipment may comprise electronic noses as being disclosed in WO01/14874 and odour sampling devices with olfactory sensors as being disclosed in U.S. Pat. No. 5,697,326, the contents of which being hereby incorporated by reference. Such devices may be capable of detecting the occurrence of different types of bacteria such as, for instance, Staphylococcus aureus, Escherichia coli, Streptococcus agalactiae, Streptococcus uberis and others, as well as detecting the odour from a cow to thereby establish a general condition of the cow.

The cow identification device 8 is provided for identifying the cows before or after having entered the teat preparation station. The cow identification device 8 can therefore be located outside the teat preparation station 1 in front of the entrance gate 3a or outside the exit gate 4a, even though it is located inside the teat preparation station 1 in a preferred version.

The teat preparation station 1 of the present invention can be used with any kind of semi-batch milking system such as a rotary milking system or true batch milking system such as Herringbone or parallel stall milking systems. It may also be used with a milking system comprising one or several voluntary or automatic milking stations.

Generally, the milking system 11 comprises at least one milking stall 13 or milking position, at which a cow can be milked using milking equipment provided in the milking stall 13. Typically, a plurality of milking stalls 13 are provided to allow several cows to be milked simultaneously. Preferably, the milking system 11 has a processing and control device 14 for the main processing and control of the milking system and at least one robot arm 15 for attaching milking equipment to the teats of the cows that are present in the milking system 11. In the illustrated case, a rotary milking system 11 having 20 milking stalls is disclosed.

In one version, the processing and control device 7 is provided to automatically determine, for each of the cows present in the teat preparation area 2 of the teat preparation station 1, whether the cow is healthy or ill; and to automatically notify the processing and control device of the milking system of ill cows among the cows. Hereby, the milking system 11 knows in advance which cows are ill and when ill cows enter the milking system 11 proper action(s) can be taken immediately.

The traffic pattern of cows 10 through the teat preparation station 1 and the milking system 11 is indicated by arrows in FIG. 1.

The teat preparation station of FIG. 1 allows for the extraction of important data of the milk from the cows before they are actually entering the milking system 11. The time the cows spend in the milking system 11 is thus minimized. Further, the space in the milking stalls 13 of the milking system 11 can be efficiently used for milking equipment as there is no need for teat preparation equipment there.

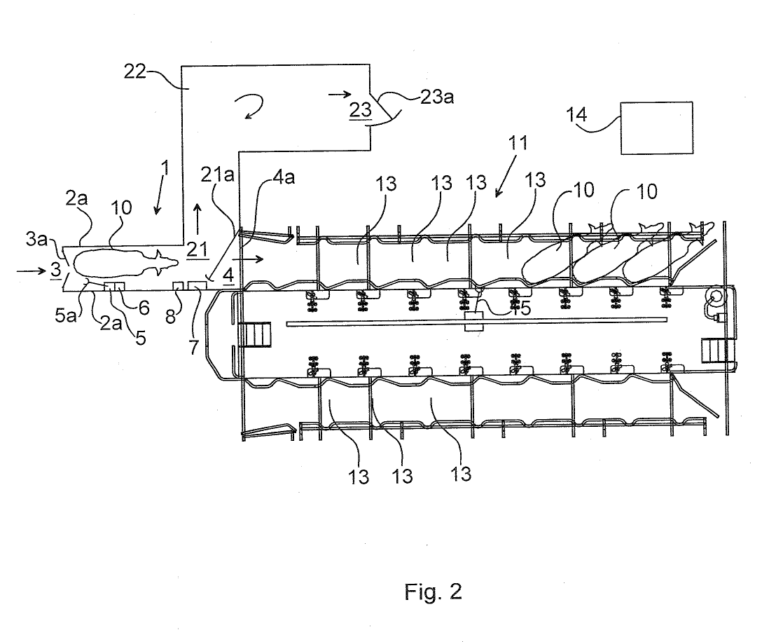

With reference next to FIG. 2 another embodiment of the invention is overviewed. This embodiment differs from the embodiment illustrated in FIG. 1 in that the teat preparation station has a second exit 21 leading to any of a waiting, treating, resting, and/or feeding area 22. A second computer-controlled exit door or gate 21a is provided in front of the second exit 21. The waiting, treating, resting, and/or feeding area 22 may be provided with an exit 23 and a computer-controlled door or gate 23a in front thereof to allow cows in the waiting, treating, resting, and/or feeding area 22 to leave it either through the second teat preparation station exit 21 or through the waiting, treating, resting, and/or feeding area exit 23.

Further, the processing and control device 7 controls the first 4a and second exit gates 21a of the teat preparation station 1 so that each of the cows present in the teat preparation station 1 is automatically allowed to leave the teat preparation station 1 through a selected one of the first 4 and second 21 exits. Preferably the selection of the exit is made based on the result of the analysis made by the analyzing equipment.

The milking system 11 illustrated in FIG. 2 is a batch wise milking system of the Herringbone type with two rows of milking stalls 13 (even though any milking system can be used with the teat preparation station 1 of FIG. 2). The teat preparation station 1 connects directly to the upper row of milking stalls 13, i.e. the exit gate 4a of the teat preparation station 1 constitutes the entrance gate to the upper row of milking stalls.

Conveniently, a further teat preparation station (not illustrated) may be arranged in front of the lower row of milking stalls 13 for preparation of teats of cows intended to be milked in the milking stalls 13 of the lower row. The further teat preparation station may be configured to operate in a similar manner as the illustrated teat preparation station.

In one version, the teat preparation station 1 comprises functionality in order to automatically determine, for each of the cows that enter the teat preparation station 1, whether the cow is healthy or ill. The processing and control device 7 controls then the first 4a and second exit gates 21a of the teat preparation station 1 so that healthy cows are automatically allowed to leave the teat preparation station 1 through the first exit 4 and to move on to the milking system 11, whereas ill cows are allowed to leave the teat preparation station 1 through said second exit 21 and to move on to the waiting, treating, resting, and/or feeding area 22. In the area 22 the ill cows are kept while the healthy cows are milked in the milking system with the purpose of milking the ill cows in the milking system 11 after having milked the healthy cows, or with the purpose of milking the ill cows at another occasion.

During the waiting time that cows can be treated, allowed to rest, or fed.

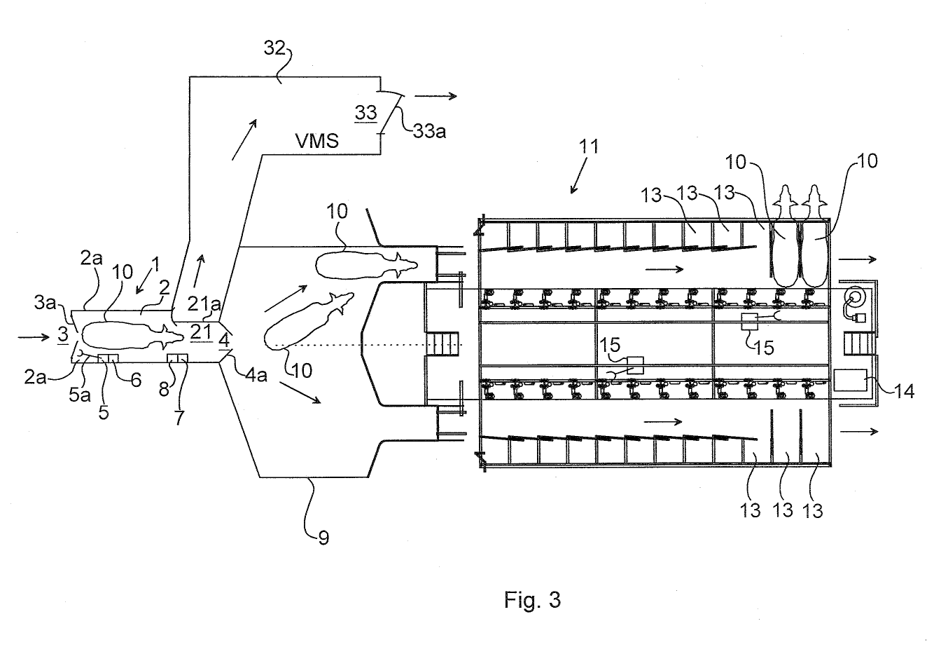

A further embodiment of the invention is illustrated in FIG. 3 and differs from the embodiment in FIG. 2 in that the second exit 21 leads to a milking area 32 separate from the milking system 11. The milking area 32 may comprise a voluntary or automatic milking station (not explicitly illustrated) provided for milking the ill cows, possibly while treating, inspecting further, or taking samples, e.g. milk samples, from, the ill cows. The milking area 32 may be provided with an exit 33 and a computer-controlled door or gate 33a in front thereof to allow cows in the milking area 32 to leave the milking area 32.

The milking system 11 illustrated in FIG. 3 is a batch wise milking system of the parallel stall type with two rows of milking stalls 13 (even though any milking system can be used with the teat preparation station 1 of FIG. 3). The teat preparation station 1 is connected to both rows of milking stalls 13 through the passage way 9.

In FIGS. 2 and 3 the traffic pattern of cows 10 through the teat preparation station 1 and the milking system 11 is just as in FIG. 1 indicated by arrows.

The teat preparation station of FIGS. 2 and 3 allows for the direction of each of the cows either to the milking system 11 or elsewhere after the teat preparation of the cow has been completed in the teat preparation station 1. In the embodiment of FIG. 2 the cows can be directed to any of a waiting, treating, resting, and/or feeding area, whereas in the embodiment of FIG. 3 the cows can be directed to a milking area separate to the milking system 11. The decision may e.g. be taken based on the identity of the cow passing through the teat preparation station 1 or be based on measurements made in the teat preparation station 1.

Only cows that are to be milked in the milking system 11 are preferably allowed to enter the milking system 11. Hereby, the utilization of the milking system 11 can be increased. Further, as was the case with the embodiment of FIG. 1, the time the cows spend in the milking system 11 is minimized and the space in the milking stalls 13 can be efficiently used for milking equipment as there is no need for teat preparation equipment there.

In a yet further embodiment of the present invention, any of the teat preparation stations 1 illustrated in FIGS. 1-3 may comprise teat preparation equipment 5 provided for automatically preparing the teats of a cow in the teat preparation area 2 by applying at least one substance to the teats of the cow.

The substance may be a cleaning substance such as a detergent, a cleaning additive, a disinfection substance such as iodine, a pre-milking dipping substance such as a halogen-containing hydrocarbon substance, or a trace substance mixed with any other active substance and used for the sole purpose as a tracer for the active substance with which it was mixed.

After the application of the substance the teats of the cow are cleaned and/or flushed with e.g. pure water thereby intending to remove the substance from the teats of the cow so that the substance will not contaminate milk during subsequent milking of the cow. The substance may alternatively be removed by other means.

After having cleaned or flushed the teats of the cow, the analyzing equipment 6, which in this embodiment comprises teat analyzing equipment, automatically measures the substance applied to the teats of the cow either directly at teats of the cow or by analyzing a fluid that is passed by the teats of the cow.

If the substance is still present, a further cleaning or flushing procedure of the teats may be performed, or a neutralizing agent or chemical reactant may be added, whichever will be the case, to remove residues of the substance that are still left at the teats. After this, the presence of the substance at the teats of is advantageously measured again to ensure that the substance is efficiently removed. If required the steps of removing residues of the substance from the teats of the cow and measuring presence of the substance at the teats of the cow may have to be repeated.

This embodiment of the invention may be employed in any kind of teat preparation module, that is, not only in any of the teat preparation stations 1 of FIGS. 1-3, but also in a teat preparation module implemented in a milking stall.

1. A teat preparation station (1) for preparation of teats of milking animals prior to intentionally being milked in a milking system (11) equipped with at least one milking stall (13), wherein said teat preparation station comprises:
a teat preparation area (2) housing at least one milking animal at a time;
an exit (4) leading to said milking system; and
pre-milking equipment (5) provided for automatically pre-milking milking animals in said teat preparation area, characterized in that said teat preparation station comprises
milk quality analyzing equipment (6) provided for automatically analyzing pre-milk from said milking animals; and/or
teat and/or udder inspection equipment (6) provided for automatically inspecting the teats and/or udders of said milking animals.

2. The teat preparation station of claim 1 wherein said milk quality analyzing equipment (6) is provided for detecting abnormal milk from each of said milking animals indicating that the milking animal is ill.

3. The teat preparation station of claim 1 wherein said milk quality analyzing equipment (6) is provided for measuring conductivity, somatic cells, bacteria, or particles in milk from each of said milking animals.

4. The teat preparation station of claim 3 wherein said milk quality analyzing equipment (6) is provided for measuring the occurrence of flocculation in milk from each of said milking animals.

5. The teat preparation station of claim 1 wherein said milk quality analyzing equipment (6) is a device for non-contacting measurements, particularly an optical device.

6. The teat preparation station of claim 1 wherein said pre-milking equipment (5) comprises a robot arm provided for attaching at least one end of said pre-milking equipment (5) to the teats of said milking animals.

7. The teat preparation station of claim 1 wherein said teat preparation area (2) is an enclosed area.

8. The teat preparation station of claim 1 wherein said teat preparation station comprises an identification device (8) provided for identifying said milking animals before or after having entered the teat preparation station.

9. The teat preparation station of claim 1 wherein said teat preparation station (1) is located adjacent to said milking system (11).

10. The teat preparation station of claim 1 wherein said milking system is a rotary milking system.

11. The teat preparation station of claim 1 wherein said milking system is a batch milking system.

12. The teat preparation station of claim 1 wherein said milking system is a milking system having at least one robot arm for attaching milking equipment to teats of milking animals that are to be milked in said milking system.

13. The teat preparation station of claim 1 wherein said teat and/or udder inspection equipment (6) provided for automatically inspecting the teats and/or udders of said milking animals comprises an optical inspection device and/or an odour sampling device with an olfactory sensor.

14. The teat preparation station of claim 1 comprising means (7) provided for (i) automatically determining, for each of said milking animals, whether the animal is healthy or ill; and (ii) automatically notifying said milking system of ill milking animals among said milking animals.

15. The teat preparation station of claim 1 wherein any of a waiting, treating, resting, and/or feeding area (22) or a milking area (32) separate from said milking system is accessible via said exit (4); and
said teat preparation station comprises means (7, 4a, 21a) for automatically guiding each of said milking animals leaving said teat preparation station to either said milking system or to said any of a waiting, treating, resting, and/or feeding area (22) or a milking area (32) separate from said milking system.

16. The teat preparation station of claim 15 comprising means (7) provided for automatically determining, for each of said milking animals, whether the milking animal is healthy or ill, wherein said means for automatically guiding (7, 4a, 21a) is provided for automatically guiding healthy milking animals leaving said teat preparation station to said milking system.

17. The teat preparation station of claim 16 wherein said means for automatically guiding (7, 4a, 21a) is provided for automatically guiding ill milking animals leaving said teat preparation station to a waiting area (22) wherein said ill milking animals are kept while milking said healthy milking animals in said milking system with the purpose of milking said ill milking animals in said milking system after having milked said healthy milking animals.

18. The teat preparation station of claim 16 wherein said means for automatically guiding (7, 4a, 21a) is provided for automatically guiding ill milking animals leaving said teat preparation station to a milking area (23) separate from said milking system, in which milking area (23) said ill milking animals are intended to be milked.

19. The teat preparation station of claim 18 wherein said milking area (23) houses an automated milking station.

20. The teat preparation station of claim 1 comprising
teat preparation equipment (5) provided for automatically preparing teats of milking animals in said teat preparation area by applying at least one substance to the teats of said milking animals; and
teat analyzing equipment (6) provided for automatically measuring said substance applied to the teats of said milking animals either directly at teats of said milking animals or by analyzing a fluid that is passed by the teats of said milking animals.

21. An arrangement for managing milking animals comprising the teat preparation station and the milking system as specified in claim 1.

22. A method for preparation of teats of milking animals in a teat preparation station (1) prior to intentionally being milked in a milking system (11) equipped with at least one milking stall (13), comprising the steps of:
receiving milking animals in a teat preparation area (2) capable of housing at least one milking animal at a time and having an exit (4) leading to said milking system; and
automatically pre-milking the milking animals in said teat preparation area by pre-milking equipment (5), characterized by the step of:
automatically analyzing pre-milk from said milking animals by milk quality analyzing equipment (6); and/or
automatically inspecting the teats and/or udders of said milking animals by teat and/or udder inspection equipment (6).

23. The method of claim 22 wherein it is determined, for each of said milking animals, whether the animal is healthy or ill; and said milking system is notified of ill milking animals among said milking animals.

24. The method of claim 22 wherein any of a waiting, treating, resting, and/or feeding area (22) or a milking area (32) separate from said milking system is accessible via said exit; and wherein each of said milking animals leaving said teat preparation station is automatically guided to said milking system or to said any of a waiting, treating, resting, and/or feeding area (22) or a milking area (32) separate from said milking system.

25. The method of claim 24 wherein it is automatically determined, for each of said milking animals, whether the milking animal is healthy or ill; and healthy milking animals of said milking animals leaving said teat preparation station are guided to said milking system.

26. The method of claim 25 wherein ill milking animals leaving said teat preparation station are guided to a waiting area (22) wherein said ill milking animals are kept while milking said healthy milking animals in said milking system with the purpose of milking said ill milking animals in said milking system after having milked said healthy milking animals.

27. The method of claim 25 wherein ill milking animals leaving said teat preparation station are guided to a milking area (23) separate from said milking system, in which milking area (23) said ill milking animals are intended to be milked.

28. The method of claim 22 comprising the further steps of:
automatically preparing the teats of said milking animals in said teat preparation area by applying at least one substance to the teats of said milking animals; and
automatically measuring, by teat analyzing equipment (6), said substance applied to the teats of said milking animals either directly at teats of said milking animals or by analyzing a fluid that is passed by the teats of said milking animals.

29. A teat preparation station (1) for preparation of teats of milking animals prior to intentionally being milked in a milking system (11) equipped with at least one milking stall (13), wherein said teat preparation station comprises:
a teat preparation area (2) housing at least one milking animal at a time;
exit means (4; 21) leading to said milking system; and
teat preparation equipment (5) for automatically preparing teats of milking animals in said teat preparation area, characterized in that
said exit means also leads to any of a waiting, treating, resting, and/or feeding area (22) or to a milking area (32) separate from said milking system; and
said teat preparation station comprises means (7, 4a, 21a) for automatically guiding each of said milking animals leaving said teat preparation station to either said milking system or to said any of a waiting, treating, resting, and/or feeding area (22) or to a milking area (32) separate from said milking system.

30. The teat preparation station of claim 29 comprising means (7) provided for automatically determining, for each of said milking animals, whether the milking animal is healthy or ill, wherein said means for automatically guiding (7, 4a, 21a) is provided for automatically guiding healthy milking animals leaving said teat preparation station to said milking system and ill milking animals leaving said teat preparation station to said any of a waiting, treating, resting, and/or feeding area (22) or to a milking area (32) separate from said milking system.

31. A method for managing milking animals prior to intentionally being milked in a milking system (11) equipped with at least one milking stall (13), characterized by the steps of:
receiving milking animals in a teat preparation station capable of housing at least one milking animal at a time and having exit means (4, 21) leading to said milking system and to any of a waiting, treating, resting, and/or feeding area (22) or to a milking area (32) separate from said milking system;
automatically preparing the teats of the milking animals in said teat preparation station by teat preparation equipment (5); and
automatically guiding each of the milking animals leaving said teat preparation station to either said milking system or to said any of a waiting, treating, resting, and/or feeding area (22) or to a milking area (32) separate from said milking system.

32. A teat preparation arrangement for preparation of teats of milking animals prior to intentionally being milked in a milking system (11) equipped with at least one milking stall (13), wherein said teat preparation station comprises
teat preparation equipment (5) provided for automatically preparing teats of milking animals in said teat preparation area by applying at least one substance to the teats of said milking animals, characterized in that said teat preparation station comprises
teat analyzing equipment (6) provided for automatically measuring said substance applied to the teats of said milking animals either directly at teats of said milking animals or by analyzing a fluid that is passed by the teats of said milking animals.

33. The teat preparation arrangement of claim 32 comprising a teat preparation area (2) housing at least one milking animal at a time, and an exit (4) leading to said milking system, wherein said teat preparation equipment is provided for automatically preparing the teats of said milking animals in said teat preparation area (2).

34. A method for preparation of teats of milking animals prior to intentionally being milked in a milking system (11) equipped with at least one milking stall (13), wherein said teat preparation method comprises the step of automatically preparing teats of milking animals in said teat preparation area by applying at least one substance to the teats of said milking animals, and is characterized by the step of automatically measuring said substance applied to the teats of said milking animals either directly at teats of said milking animals or by analyzing a fluid that is passed by the teats of said milking animals.
